(19) United States
(12) Patent Application Publication
(10) Pub. No.: US 2019/0334872 A1
(43) Pub. Date: Oct. 31, 2019

(54) ADVERTISEMENT INTERCEPTION METHOD, TERMINAL DEVICE AND STORAGE MEDIUM

(71) Applicant: BEIJING KINGSOFT INTERNET SECURITY SOFTWARE CO., LTD., Beijing (CN)

(72) Inventor: Guanxiang Wang, Beijing (CN)

(73) Assignee: BEIJING KINGSOFT INTERNET SECURITY SOFTWARE CO., LTD., Beijing (CN)

(21) Appl. No.: 16/407,975

(22) Filed: May 9, 2019

Related U.S. Application Data
(63) Continuation of application No. PCT/CN2017/106846, filed on Oct. 19, 2017.

(30) Foreign Application Priority Data
Dec. 28, 2016 (CN) 201611235421.8

(51) Int. Cl. H04L 29/06; G06Q 30/02

(52) U.S. Cl. CPC H04L 63/0272; H04L 63/10; G06Q 30/0277

(57) ABSTRACT

An advertisement interception method and apparatus, and a terminal device. The method includes establishing a VPN service; acquiring a webpage access request of a webpage when monitoring the webpage being requested by a browser application based on the VPN service; acquiring URL address information in a page corresponding to the webpage access request; determining whether the URL address information contains an advertisement URL; and preventing the advertisement URL from making a request to a corresponding advertisement server when the URL address information contains the advertisement URL.

### CROSS-REFERENCE TO RELATED APPLICATION

This application a continuation application of International Application No. PCT/CN2017/106846, filed on Oct. 19, 2017, which claims the priority of the Chinese Patent Application No. 201611235421.8 filed on Dec. 28, 2016 by BEIJING KINGSOFT INTERNET SECURITY SOFTWARE CO., LTD., entitled “Advertising Interception Method and Apparatus, and Terminal Device”.

### TECHNICAL FIELD

The present disclosure relates to the field of Internet technology, and in particular, to an advertisement interception method, a terminal device and a storage medium.

### BACKGROUND

With the rapid development of Internet technology, terminal devices have gradually become an indispensable tool for people to quickly access web pages in their daily lives. In particular, the user may read novels, watch videos, browse web pages, and the like through the terminal device anytime and anywhere. However, the terminal device brings some troubles at the same time of bringing convenience to the user. For example, when a user browses a webpage through a terminal device, an advertisement page may pop up at some time, thereby affecting normal browsing for the user.

In order to ensure that the user can browse the web or read the content better, in the related art, some advertisement blocking operations are proposed to be performed on the browser application of the terminal device. For example, by installing a plug-in in the browser application to implement the advertisement interception in the browser application. Although the above method may intercept the advertisement in the browser application to a certain extent, the installed plug-in has compatibility problems and even leads to leakage of user information.

### SUMMARY

The objective of the present disclosure is to solve at least one of the above technical problems to some extent.

To this end, embodiments of the present disclosure provides an advertisement interception method.

Embodiments of the present disclosure also propose a terminal device.

Embodiments of the present disclosure also propose a storage medium.

Embodiments of the present disclosure provide an advertisement interception method. The method may include: establishing a VPN service; acquiring a webpage access request of a webpage when monitoring the webpage being requested by a browser application based on the VPN service; acquiring URL address information in a page corresponding to the webpage access request; determining whether the URL address information contains an advertisement URL; and preventing the advertisement URL from making a request to a corresponding advertisement server when the URL address information contains the advertisement URL.

Embodiments of the present disclosure provide a terminal device. The terminal device may include a processor and a memory, in which the memory is configured to store a executable program code; and the processor is configured to execute a program corresponding to the executable program code by reading the executable program code stored in the memory, such that the processor is caused to perform acts of: establishing a VPN service; acquiring a webpage access request of a webpage when monitoring the webpage being requested by a browser application based on the VPN service; acquiring URL address information in a page corresponding to the webpage access request; determining whether the URL address information contains an advertisement URL; and preventing the advertisement URL from making a request to a corresponding advertisement server when the URL address information contains the advertisement URL.

Embodiments of the present disclosure provide a storage medium, configured to store an application for performing any of the above-mentioned advertisement interception methods. Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

The above and/or additional aspects and advantages of the present disclosure will become apparent and easily to be understood with reference to the accompanying drawings, in which,

FIG. 1 is a flow chart of an advertisement interception method according to an embodiment of the present disclosure;

FIG. 2 is a flow chart of an advertisement interception method according to another embodiment of the present disclosure;

FIG. 3 is a schematic diagram of an interception information setting interface of the present disclosure;

FIG. 4 is a schematic diagram of an advertisement interception data statistical result of the present disclosure;

FIG. 5 is a schematic structural diagram of an advertisement interception apparatus according to an embodiment of the present disclosure;

FIG. 6 is a schematic structural diagram of an advertisement interception apparatus according to another embodiment of the present disclosure; and

FIG. 7 is a schematic structural diagram of a terminal device according to an embodiment of the present disclosure.

### DETAILED DESCRIPTION

Embodiments of the present disclosure are described in detail below, and the examples of the embodiments are illustrated in the drawings, in which the same or similar reference numerals are used to refer to the same or similar elements or elements having the same or similar functions. The embodiments described below with reference to the accompanying drawings are intended to be illustrative, and are not to be construed as limitations.

In order to solve the technical problems such as incompatibility and insecurity of the user information in the browser application in the prior art, the present embodiment proposes an advertisement interception method. With this method, the effective advertisement interception in the browser application may be achieved, such that enables users to browse the web more comfortably, neatly and safely.

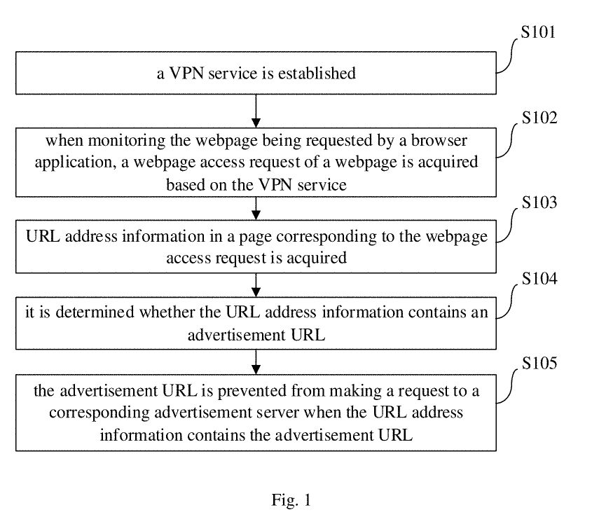

An advertisement interception method proposed by the embodiment of the first aspect of the present disclosure will be described below with reference to FIG. 1.

FIG. 1 is a flow chart of an advertisement interception method according to an embodiment of the present disclosure. As illustrated in FIG. 1, an advertisement interception method according to an embodiment of the present disclosure may include followings.

At block S101, a VPN service is established.

It should be noted that the advertisement interception method in this embodiment is implemented by using a VPN (Virtual Private Network) service established in the terminal device. By establishing a VPN service, control and management authority of other applications may be acquired, such that all user's request operations may be monitored and managed through the VPN service.

The terminal device may be, but not limited to, a smart device, a palmtop computer, a PAD etc. having a network communication function.

For example, it is assumed that the advertisement interception method of the embodiment of the present disclosure may be applied to a terminal device, and the terminal device may provide an application for establishing a VPN service function for a user, and may establish the VPN service when detecting that the user initiates the application. At the same time, the permission reminder of the authorization management may be automatically popped up to remind the user whether to authorize the VPN service to make the VPN service have the management authority. The reminder may be a reminder interface, or may be a reminder message, or may be other forms of reminders, such as voice reminders, which will not be limited herein.

After receiving the reminder information, the user may determine whether to authorize the VPN service according to his own requirements. If the user determines to authorize the VPN service, he/she may click the authorization button in the VPN permission reminder to establish the VPN service and assign the management authority for the VPN service. Of course, there are many ways to authorize the VPN service in this embodiment, which will not be described herein.

At block S102, when monitoring the webpage being requested by a browser application, a webpage access request of a webpage is acquired based on the VPN service.

Specifically, after the terminal device establishes the VPN service, the specific operation performed by the user using the browser application may be monitored based on the VPN service, or specific operation of another application invoking the browser application to access a certain webpage in the terminal device may be monitored. The browser application may be, but not limited to, an application with a query browsing service such as Sohu Browser, a Baidu Browser, or QQ Browser.

More specifically, when the user or other application monitors the webpage through the browser application through the VPN service, the webpage access request of the webpage may be acquired to perform a detecting operation on the webpage access request through the VPN service.

At block S103, URL address information in a page corresponding to the webpage access request is acquired.

Specifically, after acquiring the webpage access request of the webpage, the webpage may be requested for a corresponding server according to the webpage access request, to obtain a corresponding page returned by the server according to the webpage access request, and resources in the webpage may be parsed to obtain the URL address information in the page, so as to further perform the judgment operation according to the URL address information.

At block S104, it is determined whether the URL address information contains an advertisement URL.

At block S105, the advertisement URL is prevented from making a request to a corresponding advertisement server when the URL address information contains the advertisement URL.

Specifically, the VPN service determines, according to the parsed page URL address information, whether the advertisement URL is included in the URL information in the following manners.

In a first example, it may be determined based on keywords in the URL address information.

In a second example, it may be determined based on a code field in the URL address information.

In a third example, it may be determined according to a preset rule, in which the preset rule may be understood as an advertisement format rule. For example, the advertisement format rule may be an advertisement code rule in a source code corresponding to a webpage.

It should be noted that, the foregoing manners of determining whether the URL address information contains the advertisement URL are merely exemplary, and different determination manners may be set according to actual needs, and are not specifically limited herein.

When it is determined that the URL address information contains the advertisement URL, the VPN service intercepts the advertisement URL in the URL address information, that is, it may be prevented from performing an operation of requesting the advertisement URL to the corresponding advertisement server, such that the browser application no longer loads the resource information corresponding to the advertisement URL.

In order to enhance the user experience, optionally, in an embodiment of the present disclosure, after the advertisement URL is intercepted from being requested by the corresponding advertisement server, the webpage resource information intercepting the advertisement URL may be loaded by the browser application, in which, the display region corresponding to the originally intercepted advertisement URL of the webpage may be identified by a default icon, or the display region may be directly set to blank.

With the advertisement interception method according to embodiments of the present disclosure, a VPN service is established in the mobile terminal to monitor the webpage being requested by a browser application, a webpage access request of a webpage is acquired, URL address information in a page corresponding to the webpage access request is acquired, and it is determined whether the URL address information contains an advertisement URL, and if the URL address information contains the advertisement URL, the advertisement URL is prevented from making a request to a corresponding advertisement server. Therefore, an effective advertisement interception in a browser application may be achieved, such that the accuracy of advertisement interception may be improved and problems caused by installation of plug-ins, such as incompatibility and leakage of the user information, may be avoided, thereby satisfying the needs of users and enhancing the user experience.

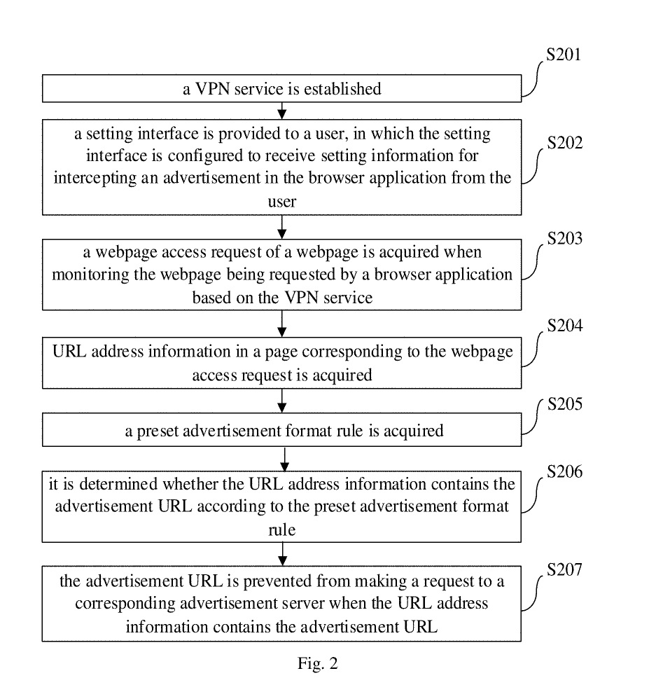

FIG. 2 is a flow chart of an advertisement interception method according to another embodiment of the present disclosure. As illustrated in FIG. 2, the advertisement interception of the embodiment of the present disclosure may include followings.

At block S201, a VPN service is established.

At block S202, a setting interface is provided to a user, in which the setting interface is configured to receive setting information for intercepting an advertisement in the browser application from the user.

Specifically, in this embodiment, after the VPN service is established in the terminal device, the setting interface may be provided to the user, such that the user may set the interception information of the VPN service according to the requirement. The set interception information may include interception amount setting information and/or timing interception setting information and the like.

In this embodiment, the interception setting of the browser application specifically includes the following manners, as illustrated in followings.

In a first example, the interception amount information is set separately.

For example, if more than one browser application such as Google Browser, Firefox Browser, or 360 Browser is installed in the terminal device, the user may set one of them as an intercepting object according to his/her own needs, or set two of them as intercepting objects, or set the interception object in the default way. It should be noted that the default way in the terminal device is to set all browser applications as intercept objects.

In a second example, the timing intercept information is set separately.

Specifically, by setting the corresponding timing interception setting information, the terminal device may perform the corresponding intercepting operation according to the timing information set by the user, such that the user's requirements may be better satisfied, thereby avoiding the annoying for the user normally browsing the page when the advertisement page continuously popped up during the using process.

It should be noted that, in this embodiment, when the user sets the timing interception information, the interception amount information in the terminal device is set according to the default interception amount.

In a third example, the interception amount information and the corresponding timing interception information are set simultaneously.

Specifically, the user may set the corresponding interception amount information in the setting interface as requested, and then set the corresponding timing interception information for the set interception amount information, thereby realizing the purpose of personalizing the interception information, and is more suitable for different users. Different needs further enhance the needs of users.

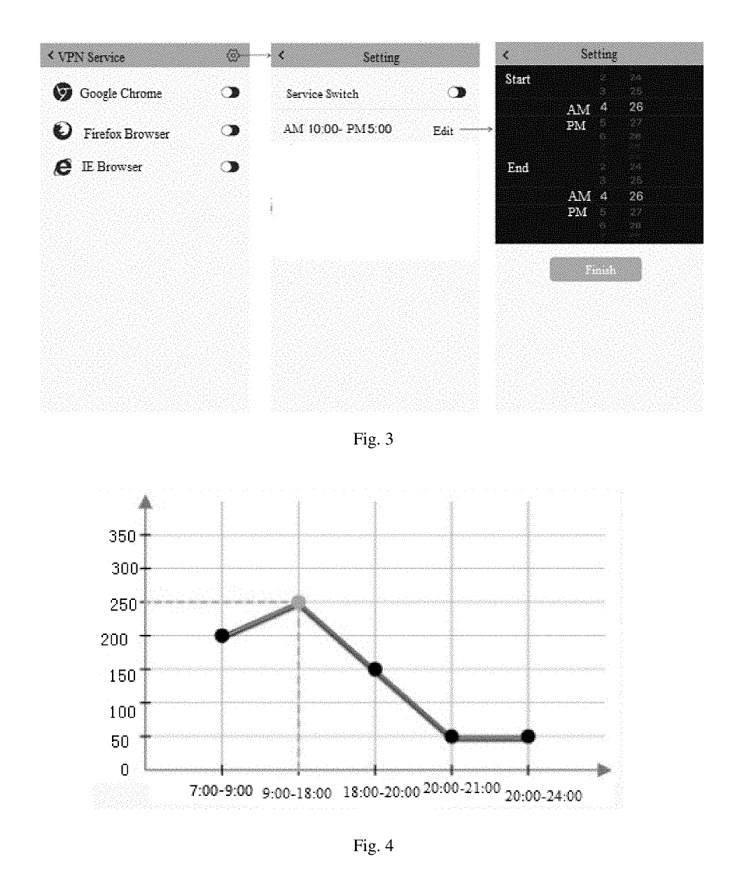

For example, after the user sets the interception amount information in the default manner, the operation for setting the corresponding timing interception information is also performed. At this time, the set interception amount and the set interception time period are displayed in the setting interface of the terminal device. For example, as shown in FIG. 3, the application in the terminal device may be scanned, and three applications having the function of accessing the webpage, such as Google Chrome, Firefox Browser, and IE Browser, may be obtained. These three applications are displayed in the setting interface, and a setting button is set for each application, and the user may select an application which needs to implement the advertisement interception function through the VPN service as requested. After the user determines the browser application that needs the VPN service, the corresponding timing interception information may be set for the selected browser application; the user may set the time period for executing the VPN service in the timing setting interface, as shown in the figure, the time period includes a start time and an end time, and after the user sets the corresponding timing time, click the completion button to implement the corresponding browser application to execute the corresponding VPN service within the set time period. It is assumed that in the present embodiment, the set start time is 10:26 am and the end time is 16:45 pm, and the set time interval corresponding to the intercept amount information is 10:26 am to 16:45 pm.

Further, after setting the interception information is completed, the VPN service may perform a corresponding monitoring operation according to the set interception information.

At block S203, a webpage access request of a webpage is acquired when monitoring the webpage being requested by a browser application based on the VPN service.

At block S204, URL address information in a page corresponding to the webpage access request is acquired.

At block S205, a preset advertisement format rule is acquired.

Specifically, in this embodiment, the specific implementation process of acquiring the preset advertisement format rule may include: determining a type of the browser application; and acquiring the preset advertisement format rule according to the type of the browser application.

It may be understood that different browser applications in the terminal device may respectively correspond to different code rules. Based on this reason, the corresponding preset advertisement format rules may be obtained according to the type of the browser application, such that the subsequent act at block S205 in which it is determined whether the URL address information contains an advertisement URL is performed according to the preset advertisement rule. It should be noted that the advertisement format rules may be edited and generated based on the programming language such as C++, Java, and the like.

It may also be understood that the advertisement may be displayed in a manner of a banner, a couplet, in a bottom right corner, popping up, and the like. Optionally, in this embodiment, the advertisement format rule may include a format rule corresponding to various forms of advertisement.

At block S206, it is determined whether the URL address information contains the advertisement URL according to the preset advertisement format rule.

Specifically, after the preset advertisement format rule is obtained, the advertisement format rule may be matched with the parsed URL address information. If the matching is successful, it is determined that the URL address information includes the advertisement URL, and if the matching fails, it is determined that the URL address information does not include the advertisement URL.

The advertisement format rule may be a rule including an advertisement keyword, a rule including an advertisement code, a rule including an advertisement server address, and may also include other information, which is not limited herein.

At block S207, the advertisement URL is prevented from making a request to a corresponding advertisement server when the URL address information contains the advertisement URL.

With the advertisement interception method of the embodiment of the present disclosure, a setting interface is provided to the user, and the setting information of the user for the advertisement interception in the browser application may be received through the setting interface, such that the personalized requirement of the user may be satisfied. Moreover, the preset advertisement format rule may be acquired to determine whether the URL address contains the advertisement URL, which effectively improves the accuracy of the judgment, avoids the occurrence of misjudgment, and improves the user experience.

Further, based on the foregoing embodiment, in an embodiment of the present disclosure, in the process of performing advertisement interception, data statistics of the advertisement interception based on the VPN service may also be performed, and the statistical result is provided to the user.

Specifically, when the VPN service in the terminal device intercepts the webpage that includes the advertisement URL, the number of the intercepted advertisements may be counted, and the statistical result is provided to the user, such that the user may more intuitively view the intercepted specific situation. For example, as shown in FIG. 4, it is possible to show the user information such as how many advertisements were intercepted during which time period.

In order to implement the above embodiments, the present disclosure also proposes an advertisement intercepting apparatus.

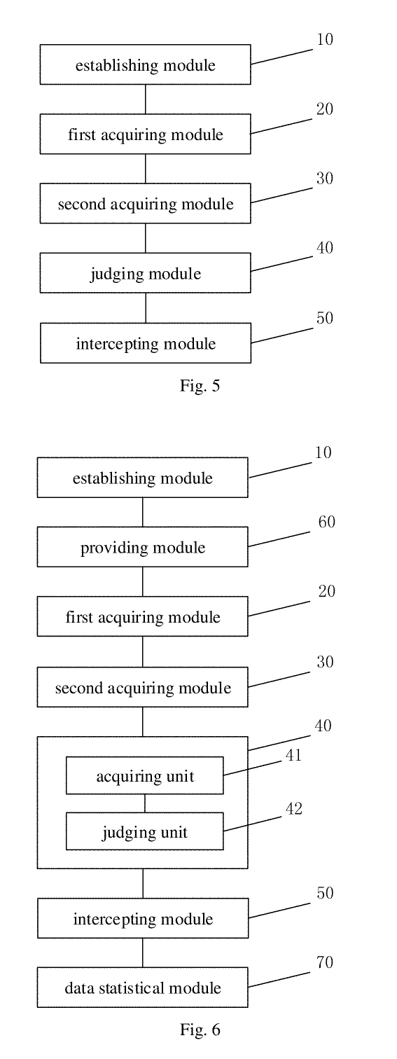

FIG. 5 is a schematic structural diagram of an advertisement interception apparatus according to an embodiment of the present disclosure.

As shown in FIG. 5, the advertisement interception apparatus of the embodiment of the present disclosure includes: an establishing module 10, a first acquiring module 20, a second acquiring module 30, a judging module 40, and an intercepting module 50.

Specifically, the establishing module 10 is configured to establish a VPN service. It should be noted that the advertisement interception apparatus in this embodiment is implemented by using a VPN (Virtual Private Network) service established in the terminal device. By establishing a VPN service, control and management authority of other applications may be acquired, such that all user's request operations may be monitored and managed through the VPN service.

The terminal device may be, but not limited to, a smart device, a palmtop computer, a PAD etc. having a network communication function.

For example, it is assumed that the advertisement interception apparatus of the embodiment of the present disclosure may be applied to a terminal device, and the advertisement interception apparatus may be represented in a form of an application. When it is detected that the user initiates the application, the VPN service may be established by the establishing module 10, and meanwhile, the permission reminder of the authorization management may be automatically popped up to remind the user whether to authorize the VPN service to make the VPN service have the management authority. The reminder may be a reminder interface, or may be a reminder message, or may be other forms of reminders, such as voice reminders, which will not be limited herein.

After receiving the reminder information, the user may determine whether to authorize the VPN service according to his own requirements. If the user determines to authorize the VPN service, he/she may click the authorization button in the VPN permission reminder to establish the VPN service and assign the management authority for the VPN service. Of course, there are many ways to authorize the VPN service in this embodiment, which will not be described herein.

The first acquiring module 20 is configured to acquire a webpage access request of a webpage when monitoring the webpage being requested by a browser application based on the VPN service.

Specifically, after the establishing module 10 establishes the VPN service, the first acquiring module 20 may monitor the specific operation performed by the user using the browser application or specific operation of another application invoking the browser application to access a certain webpage in the terminal device based on the VPN service. The browser application may be, but not limited to, an application with a query browsing service such as Sohu Browser, a Baidu Browser, or QQ Browser.

More specifically, when the user or other application monitors the webpage through the browser application through the VPN service, the webpage access request of the webpage may be acquired by the first acquiring module 20 so as to perform a detecting operation on the webpage access request through the VPN service.

The second acquiring module 30 is configured to acquire URL address information in a page corresponding to the webpage access request.

Specifically, after the first acquiring module 20 acquires the webpage access request of the webpage, the second acquiring module 30 may request the webpage for a corresponding server according to the webpage access request, so as to obtain a corresponding page returned by the server according to the webpage access request, and resources in the webpage may be parsed to obtain the URL address information in the page, so as to further perform the judgment operation according to the URL address information.

The judging module 40 is configured to determine whether the URL address information contains an advertisement URL.

The intercepting module 50 is configured to prevent the advertisement URL from making a request to a corresponding advertisement server when the URL address information contains the advertisement URL.

Specifically, the VPN service determines, according to the parsed page URL address information, whether the advertisement URL is included in the URL information in the following manners.

In a first example, it may be determined based on keywords in the URL address information.

In a second example, it may be determined based on a code field in the URL address information.

In a third example, it may be determined according to a preset rule, in which the preset rule may be understood as an advertisement format rule. For example, the advertisement format rule may be an advertisement code rule in a source code corresponding to a webpage.

It should be noted that, the foregoing manners of determining whether the URL address information contains the advertisement URL are merely exemplary, and different determination manners may be set according to actual needs, and are not specifically limited herein.

When it is determined that the URL address information contains the advertisement URL, the VPN service intercepts the advertisement URL in the URL address information, that is, it may be prevented from performing an operation of requesting the advertisement URL to the corresponding advertisement server, such that the browser application no longer loads the resource information corresponding to the advertisement URL.

In order to enhance the user experience, optionally, in an embodiment of the present disclosure, after the advertisement URL is intercepted from being requested by the corresponding advertisement server, the webpage resource information intercepting the advertisement URL may be loaded by the browser application, in which, the display region corresponding to the originally intercepted advertisement URL of the webpage may be identified by a default icon, or the display region may be directly set to blank.

With the advertisement interception apparatus according to embodiments of the present disclosure, the establishing module establishes a VPN service in the mobile terminal, and when it is monitored that the webpage is requested by a browser application, the first acquiring module acquires a webpage access request for the webpage. The second acquiring module acquires URL address information in a page corresponding to the webpage access request, and the judging module determines whether the URL address information contains an advertisement URL. If it is determined that the URL address information contains the advertisement URL, the intercepting module prevents the advertisement URL from making a request to a corresponding advertisement server. Therefore, an effective advertisement interception in a browser application may be achieved, such that the accuracy of advertisement interception may be improved and problems caused by installation of plug-ins, such as incompatibility and leakage of the user information, may be avoided, thereby satisfying the needs of users and enhancing the user experience.

FIG. 6 is a schematic structural diagram of an advertisement interception apparatus according to another embodiment of the present disclosure.

In order to better meet the user's personalized needs and further enhance the user experience, in the embodiment of the present disclosure, the user is also provided with a setting interface, and the setting interface is configured to receive the user's setting information for the advertisement interception in the browser application. Specifically, as shown in FIG. 6, the advertisement interception apparatus of the embodiment of the present disclosure includes: an establishing module 10, a first acquiring module 20, a second acquiring module 30, a judging module 40, an intercepting module 50, a providing module 60, and a data statistical module 70.

Specifically, the establishing module 10 is configured to establish a VPN service.

The providing module 60 is configured to provide a setting interface to a user, in which the setting interface is configured to receive setting information for intercepting an advertisement in the browser application from the user.

Specifically, in this embodiment, after the establishing module 10 establishes the VPN service in the terminal device, the providing module 60 may provide the setting interface to the user, such that the user may set the interception information of the VPN service according to the requirement. The set interception information may include interception amount setting information and/or timing interception setting information and the like.

In this embodiment, the interception setting of the browser application specifically includes the following manners, as illustrated in followings.

In a first example, the interception amount information is set separately.

For example, if more than one browser application such as Google Browser, Firefox Browser, or 360 Browser is installed in the terminal device, the user may set one of them as an intercepting object according to his/her own needs, or set two of them as intercepting objects, or set the interception object in the default way. It should be noted that the default way in the terminal device is to set all browser applications as intercept objects.

In a second example, the timing intercept information is set separately.

Specifically, by setting the corresponding timing interception setting information, the terminal device may perform the corresponding intercepting operation according to the timing information set by the user, such that the user's requirements may be better satisfied, thereby avoiding the annoying for the user normally browsing the page when the advertisement page continuously popped up during the using process.

It should be noted that, in this embodiment, when the user sets the timing interception information, the interception amount information in the terminal device is set according to the default interception amount.

In a third example, the interception amount information and the corresponding timing interception information are set simultaneously.

Specifically, the user may set the corresponding interception amount information in the setting interface as requested, and then set the corresponding timing interception information for the set interception amount information, thereby realizing the purpose of personalizing the interception information, and is more suitable for different users. Different needs further enhance the needs of users.

For example, after the user sets the interception amount information in the default manner, the operation for setting the corresponding timing interception information is also performed. At this time, the set interception amount and the set interception time period are displayed in the setting interface of the terminal device. For example, as shown in FIG. 3, the application in the terminal device may be scanned, and three applications having the function of accessing the webpage, such as Google Chrome, Firefox Browser, and IE Browser, may be obtained. These three applications are displayed in the setting interface, and a setting button is set for each application, and the user may select an application which needs to implement the advertisement interception function through the VPN service as requested. After the user determines the browser application that needs the VPN service, the corresponding timing interception information may be set for the selected browser application; the user may set the time period for executing the VPN service in the timing setting interface, as shown in the figure, the time period includes a start time and an end time, and after the user sets the corresponding timing time, click the completion button to implement the corresponding browser application to execute the corresponding VPN service within the set time period. It is assumed that in the present embodiment, the set start time is 10:26 am and the end time is 16:45 pm, and the set time interval corresponding to the intercept amount information is 10:26 am to 16:45 pm.

Further, after setting the interception information is completed, the VPN service may perform a corresponding monitoring operation according to the set interception information.

The first acquiring module 20 is configured to acquire a webpage access request of a webpage when monitoring the webpage being requested by a browser application based on the VPN service. More specifically, the VPN service may monitor the application in the terminal device based on the setting information in the setting interface, and when it is monitored that there is an operation of requesting a webpage through the browser application currently, the first acquiring module 20 may acquire a webpage access request for the webpage. The second acquiring module 30 is configured to acquire URL address information in a page corresponding to the webpage access request.

The judging module 40 is configured to determine whether the URL address information contains an advertisement URL.

Specifically, in an embodiment of the present disclosure, the judging module 40 includes: an acquiring unit 41 and a judging unit 42. The acquiring unit 41 is configured to acquire a preset advertisement format rule. The acquiring unit 41 is specifically configured to: determine a type of the browser application; and to acquire a corresponding preset advertisement format rule according to the type of the browse application.

It may be understood that different browser applications in the terminal device may respectively correspond to different code rules. Based on this reason, the corresponding preset advertisement format rules may be obtained according to the type of the browser application, such that the subsequent act at block S205 in which it is determined whether the URL address information contains an advertisement URL is performed according to the preset advertisement rule. It should be noted that the advertisement format rules may be edited and generated based on the programming language such as C++, Java, and the like.

It may also be understood that the advertisement may be displayed in a manner of a banner, a couplet, in a bottom right corner, popping up, and the like. Optionally, in this embodiment, the advertisement format rule may include a format rule corresponding to various forms of advertisement.

The judging unit 42 is configured to determine whether the URL address information contains the advertisement URL according to the preset advertisement format rule.

Specifically, after the preset advertisement format rule is obtained, the advertisement format rule may be matched with the parsed URL address information. If the matching is successful, it is determined that the URL address information includes the advertisement URL, and if the matching fails, the URL is determined, the URL is not included in the address information.

The advertisement format rule may be a rule including an advertisement keyword, a rule including an advertisement code, a rule including an advertisement server address, and may also be a rule including other information, which is not specifically limited herein.

The intercepting module 50 is configured to prevent the advertisement URL from making a request to a corresponding advertisement server when the URL address information contains the advertisement URL.

With the advertisement interception apparatus of the embodiment of the present disclosure, a setting interface is provided to the user, and the setting information of the user for the advertisement interception in the browser application may be received through the setting interface, such that the personalized requirement of the user may be satisfied. Moreover, the preset advertisement format rule may be acquired to determine whether the URL address contains the advertisement URL, which effectively improves the accuracy of the judgment, avoids the occurrence of misjudgment, and improves the user experience.

Further, based on the foregoing embodiment, in an embodiment of the present disclosure, in the process of the intercepting module 50 performing the advertisement interception, the advertisement interception apparatus may also include a data statistical module 70.

The data statistical module 70 is configured to perform data statistics on the advertisement interception based on the VPN service, and to provide a statistical result to a user.

Specifically, when the VPN service in the terminal device intercepts the webpage that includes the advertisement URL, the number of the intercepted advertisements may be counted, and the statistical result is provided to the user, such that the user may more intuitively view the intercepted specific situation. For example, as shown in FIG. 4, it is possible to show the user information such as how many advertisements were intercepted during which time period.

In order to implement the above embodiments, the present disclosure also proposes a terminal device.

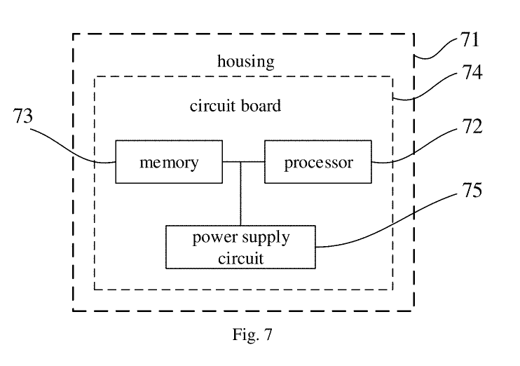

FIG. 7 is a schematic structural diagram of a terminal device according to an embodiment of the present disclosure. As shown in FIG. 7, the terminal device may include: a housing 71, a processor 72, a memory 73, a circuit board 74, and a power supply circuit 75, in which the circuit board 74 is disposed inside a space enclosed by the housing 71, the processor 72 and the a memory 73 is disposed on the circuit board 74; the power circuit 75 is configured to supply power to each circuit or component of the terminal device; the memory 73 is configured to store a executable program code; and the processor 72 is configured to execute a program corresponding to the executable program code by reading the executable program code stored in the memory 73, such that the processor is caused to perform acts of:

S701′: establishing a VPN service;

S702′: acquiring a webpage access request of a webpage when monitoring the webpage being requested by a browser application based on the VPN service;

S703′: acquiring URL address information in a page corresponding to the webpage access request;

S704′: determining whether the URL address information contains an advertisement URL; and

S705′: preventing the advertisement URL from making a request to a corresponding advertisement server when the URL address information contains the advertisement URL.

With the terminal device according to embodiments of the present disclosure, a VPN service is established in the mobile terminal to monitor the webpage being requested by a browser application, a webpage access request of a webpage is acquired, URL address information in a page corresponding to the webpage access request is acquired, and it is determined whether the URL address information contains an advertisement URL, and if the URL address information contains the advertisement URL, the advertisement URL is prevented from making a request to a corresponding advertisement server. Therefore, an effective advertisement interception in a browser application may be achieved, such that the accuracy of advertisement interception may be improved and problems caused by installation of plug-ins, such as incompatibility and leakage of the user information, may be avoided, thereby satisfying the needs of users and enhancing the user experience.

In order to implement the above embodiments, the present disclosure further provides a storage medium. The storage medium is configured to store an application for performing any of the above advertisement interception methods.

In the description of the present disclosure, it is to be understood that the terms “first” and “second” are used for descriptive purposes only and are not to be construed as indicating or implying a relative importance or implicitly indicating the number of technical features indicated. Thus, features defining “first” and “second” may include at least one of the features, either explicitly or implicitly. In the description of the present disclosure, the meaning of “a plurality of” is at least two, such as two, three, etc., unless specifically defined otherwise.

In the description of the present specification, the description with reference to the terms “one embodiment”, “some embodiments”, “example”, “specific example”, or “some examples” and the like means that specific features, structures, material or characteristics described in connection with the embodiment or example may be included in at least one embodiment or example of the present disclosure. In the present specification, the schematic representation of the above terms is not necessarily directed to the same embodiment or example. Furthermore, the particular features, structures, materials, or characteristics described may be combined in a suitable manner in any one or more embodiments or examples. In addition, various embodiments or examples described in the specification and features of various embodiments or examples may be combined and combined without departing from the scope of the disclosure.

Any process or method description in the flowcharts or otherwise described herein may be understood to represent a module, segment or portion of code including one or more executable instructions for implementing the steps of a particular logical function or process. The scope of the preferred embodiments of the disclosure includes additional implementations, in which the functions may be performed in a substantially simultaneous manner or in an opposite order depending on the functions involved, instead of in the order shown or discussed. It will be understood by those skilled in the art to which the embodiments of the present disclosure pertain.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The above mentioned storage medium may be a read only memory, a magnetic disk or an optical disk or the like. Although the embodiments of the present disclosure have been shown and described, it is understood that the above-described embodiments are illustrative and are not to be construed as limiting the scope of the disclosure. Various changes and modifications of the present disclosure may be made without departing from the spirit and scope of the present disclosure should be included in the scope of the present disclosure.

What is claimed is:

1. An advertisement interception method, comprising:
establishing a VPN service;
acquiring a webpage access request of a webpage when monitoring the webpage being requested by a browser application based on the VPN service;
acquiring URL address information in a page corresponding to the webpage access request;
determining whether the URL address information contains an advertisement URL; and
preventing the advertisement URL from making a request to a corresponding advertisement server when the URL address information contains the advertisement URL.

2. The advertisement interception method according to claim 1, wherein determining whether the URL address information contains the advertisement URL comprises:
acquiring a preset advertisement format rule; and
determining whether the URL address information contains the advertisement URL according to the preset advertisement format rule.

3. The advertisement interception method according to claim 2, wherein acquiring the preset advertisement format rule comprises:
determining a type of the browser application; and
acquiring the preset advertisement format rule according to the type of the browser application.

4. The advertisement interception method according to claim 1, further comprising:
providing a setting interface to a user, wherein the setting interface is configured to receive setting information for intercepting an advertisement in the browser application from the user.

5. The advertisement interception method according to claim 4, wherein the setting information comprises at least one of interception-amount setting information or timing-interception setting information.

6. The advertisement interception method according to claim 1, wherein in a process of performing an advertisement interception, the method further comprises:
performing data statistics on the advertisement interception based on the VPN service, and providing a statistical result to a user.

7. A terminal device, comprising a processor and a memory, wherein the memory is configured to store a executable program code; and the processor is configured to execute a program corresponding to the executable program code by reading the executable program code stored in the memory, such that the processor is caused to perform acts of:
establishing a VPN service;
acquiring a webpage access request of a webpage when monitoring the webpage being requested by a browser application based on the VPN service;
acquiring URL address information in a page corresponding to the webpage access request;
determining whether the URL address information contains an advertisement URL; and
preventing the advertisement URL from making a request to a corresponding advertisement server when the URL address information contains the advertisement URL.

8. The advertisement interception apparatus according to claim 7, wherein the processor is caused to determine whether the URL address information contains the advertisement URL by performing acts of:
acquiring a preset advertisement format rule; and
determining whether the URL address information contains the advertisement URL according to the preset advertisement format rule.

9. The advertisement interception apparatus according to claim 8, wherein the processor is caused to acquire the preset advertisement format rule by performing acts of:
determining a type of the browser application; and
acquiring the preset advertisement format rule according to the type of the browser application.

10. The advertisement interception apparatus according to claim 7, wherein the processor is caused to perform an act of:
providing a setting interface to a user, the setting interface being configured to receive setting information for intercepting an advertisement in the browser application from the user.

11. The advertisement interception apparatus according to claim 10, wherein the setting information comprises at least one of interception-amount setting information or timing-interception setting information.

12. The advertisement interception apparatus according to claim 7, wherein in a process of performing an advertisement interception, the processor is caused to perform an act of:
performing data statistics on the advertisement interception based on the VPN service, and provide a statistical result to a user.

13. A storage medium, configured to store an application for performing an advertisement interception method, wherein the advertisement interception method comprises:
establishing a VPN service;
acquiring a webpage access request of a webpage when monitoring the webpage being requested by a browser application based on the VPN service;
acquiring URL address information in a page corresponding to the webpage access request;
determining whether the URL address information contains an advertisement URL; and
preventing the advertisement URL from making a request to a corresponding advertisement server when the URL address information contains the advertisement URL.
